(19) United States
(12) Patent Application Publication
(10) Pub. No.: US 2026/0092883 A1
(43) Pub. Date: Apr. 2, 2026

(54) Soft X-Ray Tools for Semiconductor Metrology Applications

(71) Applicant: yTools Inc., Capitola, CA (US)

(72) Inventor: William A. Schumaker, Capitola, CA (US)

(73) Assignee: yTools Inc., Capitola, CA (US)

(21) Appl. No.: 19/207,274

(22) Filed: May 13, 2025

Related U.S. Application Data
(60) Provisional application No. 63/700,554, filed on Sep. 27, 2024.

(51) Int. Cl. G01N 23/20008; G01N 23/201

(52) U.S. Cl. CPC G01N 23/20008; G01N 23/201; G01N 2223/052; G01N 2223/30; G01N 2223/6116

(57) ABSTRACT

An optical system for conditioning a source beam in the soft X-ray range. The optical system is positioned and configured with a geometry to redirect a selected portion of the source beam for illuminating a semiconductor substrate at a specific angle of incidence. The optical system includes at least two optical elements. A first optical element reflects the selected portion of the source beam having a specified wavelength. The second optical element then reflects and focuses the selected portion as a target beam onto the semiconductor substrate.

### TECHNICAL FIELD

This disclosure relates generally to the use of “soft” X-ray tools for Small-Angle X-ray Scatterometry (SAXS) measurements for semiconductor metrology applications.

### BACKGROUND

X-ray-based scatterometry has been used in metrology systems for process and quality control applications. For example, CD-SAXS (Critical-Dimension Small-Angle X-ray Scattering) is a known X-ray scattering technique used by the National Institute of Standards and Technology (NIST) for measuring and characterizing nanoscale features in a semiconductor target sample. (See, e.g., https://www.nist.gov/programs-projects/critical-dimension-small-angle-x-ray-scattering-cdsaxs-next-generation-line). It would desirable, however, to improve the overall throughput and performance of such systems via compatibility with more powerful accelerator-based light sources and improved optical control, as described below.

### BRIEF SUMMARY

An optical system for conditioning a source beam in the soft X-ray range for use in a semiconductor metrology system. The optical system includes at least first optic and a second optic. The first optic is positioned to receive the source beam and configured to reflect a selected portion of the source beam having a specific wavelength. The second optic is positioned to receive the selected portion of the source beam and configured to reflect and focus it as a target beam onto a semiconductor substrate. The geometry and positions of the first and second optics are set to illuminate the target point at a specific angle of incidence. Light from the target beam that is reflected and scattered off the semiconductor substrate is collected and used to characterize the nanoscale features.

### BRIEF DESCRIPTION OF DRAWINGS

FIG. 1 illustrates examples of semiconductor devices having nanoscale features.

FIG. 2 is a schematic illustration of a metrology tool for CD-SAXS applications.

FIG. 3 is a schematic illustration of an accelerator-based light source.

FIG. 4 is a schematic illustration of a system of conditioning optics for a metrology tool.

FIG. 5 is an illustration of a metrology system embodiment having an integrated system of conditioning optics.

FIG. 6 is a schematic illustration of a monochromator selecting and passing a single wavelength.

FIG. 7 is a schematic illustration of a grating separating multiple wavelengths into different output paths.

FIG. 8 is a schematic illustration of a 4-mirror polarizer system.

FIG. 9 is a schematic illustration of a 3-mirror polarizer system.

FIG. 10 is a schematic illustration of first embodiment of a conditioning optic designed for narrow angular selection.

FIG. 11 is a schematic illustration of second embodiment of a conditioning optic designed for narrow angular selection.

FIG. 12 is a top view of a substrate having a multilayer coating with a thickness gradient.

FIG. 13 is a side view of the substrate shown in FIG. 12 further illustrating the multilayer thickness gradient.

FIG. 14 is a schematic illustration of a first embodiment of a conditioning optic designed for a large angular selection.

FIG. 15 is a schematic illustration of a second embodiment of a conditioning optic designed for a large angular selection.

FIG. 16 is a schematic illustration of a system to swap conditioning optics between different optical parameters or wavelengths.

### DETAILED DESCRIPTION

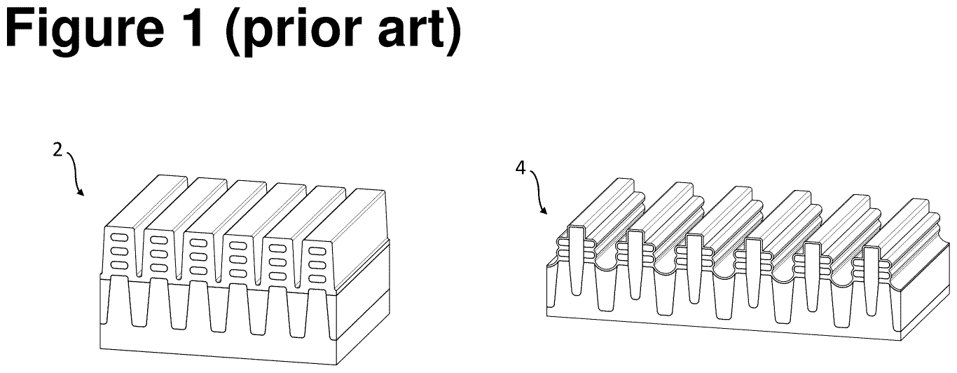

This disclosure is directed to improved optical systems and methods for measuring and characterizing nanoscale features, such as the size and shape of those features, as formed in a semiconductor substrate. FIG. 1 illustrates two examples of semiconductor devices that have nanoscale features that need to be dimensionally monitored to provide effective process control, namely, gate-all-around transistor 2 and forksheet transistor 4. These devices contain recessed nanoscale features having lengths and thicknesses on the order of tens of nanometers or less that are critical for the transistor device to function. Established methods such as optical metrology (e.g., wavelengths greater 150 nm) or electron beam microscopes either lack the resolution to measure such subsurface features or are too slow or destructive to use for in-line metrology. However, CD-SAXS methods offer both the speed and accuracy required for efficient in-line process control of these nanoscale features.

Optical conditioning systems are described for receiving and conditioning a source light beam in the soft X-ray range (approximately 1-20 nm) for delivery to, or as an integral part of, a semiconductor metrology system. However, the various figures are not drawn to scale and should be taken as illustrative only and not taken as indicative of actual angles, shapes or dimensions.

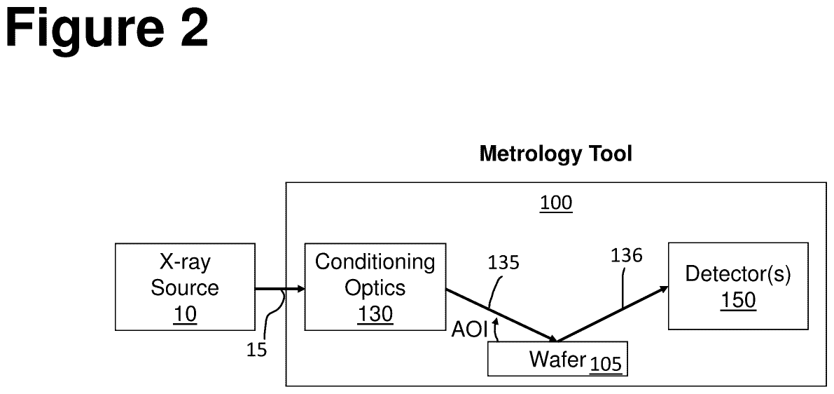

FIG. 2 is simplified schematic illustrating a metrology tool 100 for CD-SAXS applications. In this example, an external light source 10 generates a light beam 15 in the soft X-ray range, approximately 1-20 nm. The source beam 15 is directed along a beamline in a known manner into the metrology tool 100.

Upon entering the metrology tool 100, a system of conditioning optics 130 is configured with (i) an optical geometry that defines both the focus and the angle of incidence (AOI) of target beam 135; and (ii) coatings (multilayer or single layer) on the optics designed to define the wavelength selection for the desired scan profile. Thus, the conditioning optics 130 are designed and positioned in order to select and redirect a portion of the source beam 15 having a particular wavelength of interest and to focus that particular wavelength of interest as the target beam 135 at a specific AOI upon the semiconductor wafer 105. As a practical matter, a number of different sets of conditioning optics may be designed with different scan profiles for different nanoscale feature sets, for example, having different selected wavelengths, AOIs, and/or wafer rotation positions. It may also be desirable although optional to have the conditioning optics impart a desired polarization onto the target beam.

Light 136 that is reflected and scattered from the wafer 105 and its nanoscale features is collected by a detector 150, where it is converted into digital signals and sent to a processing system (not shown) where the digital signals are used to evaluate and characterize the nanoscale features formed on the wafer against the manufacturing objectives.

The AOI for the target beam 135 upon the wafer 105 is an important factor for implementing a successful scan profile and is dependent upon knowledge of the design/expected nanoscale features of the wafer, as well as the expected scattering response from those features collected as the reflected and scattered light 136. Thus, for a particular scan profile, the target beam 135 must be conditioned to have the desired spectral, spatial, and angular distribution for properly illuminating the wafer 105 in order to provide useful information for characterizing the nanoscale features based on the collected scattering data. This is done by ensuring that the geometry and positioning of the optical elements provide the desired AOL. A typical scan profile requires that a selected wavelength impinge upon the target at a particular range of AOIs, and a full data set is collected as the wafer is moved into different scan positions to obtain data for the complete scan profile. The angles shown in the examples described herein are for illustration only and are not representative of accurate scale or angles.

As one example, a conventional accelerator-based source may generate a light beam having a primary or fundamental wavelength of 13.5 nm—but the beam also includes harmonic radiation at other wavelengths. By configuring the conditioning optics appropriately; that is, by providing one or more mirrors with appropriate shapes and coatings, positioned and aligned at an appropriate angle to the source beam, a particular wavelength may be selected from the source beam and focused on a target of interest at an appropriate AOL. As noted above, different sets of conditioning optics could be configured for use with the same source, but each of the sets designed for selecting a different wavelength of interest for a different scan profile. Therefore, regardless of the nature of the source or its fundamental beam wavelength, so long as the source beam is in the soft X-ray range, conditioning optics systems can be configured and positioned to select and filter the source beam for different device features with appropriate scan profiles.

Additional details and variations for systems of conditioning optics as used in a metrology tool are described below.

### 1. THE SOURCE

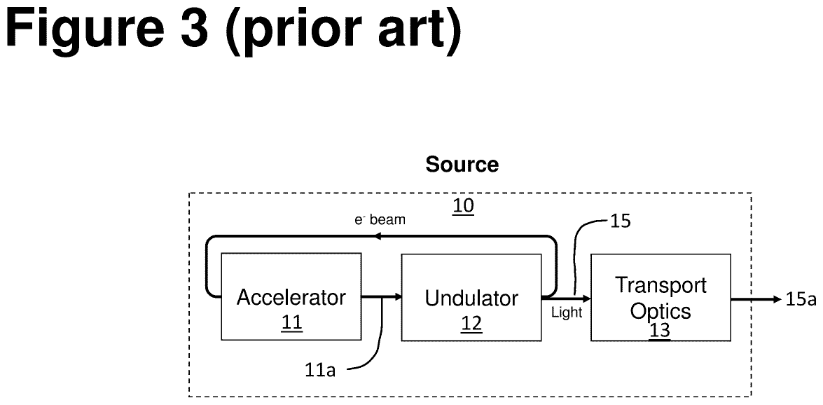

As shown in FIG. 3, a preferred light source 10 includes one or more particle accelerator modules 11 that function in a known manner to generate a low-emittance beam 11a of high-energy electrons. The electron beam 11a is passed through an undulator network 12 that uses periodic magnetic fields in a known manner to convert some of the electron beam energy into a narrow bandwidth light beam 15 of high-intensity synchrotron radiation. Typically, the electron beam is recirculated back to the accelerator module 11 after passing through the undulator network 12. Optionally, the light source 10 may also include transport optics 13 to collect the light beam 15 from the undulator 12 and transport as source beam 15a through a beam tube (not shown) to the metrology platform. For the purposes of this disclosure, references to the source beam 15 should be construed to include the variation beam 15a delivered via transport optics 13 provided with the source 10.

Accelerator-based sources are becoming commercially available as FELs (free-electron lasers) that generate high-energy, narrowband light beams from vacuum ultraviolet (VUV) wavelengths (e.g., 20-160 nm) down into the soft X-ray range (e.g. 1-20 nm). One example of an FEL source for semiconductor applications may generate an output light beam having a wavelength of 13.5 nm; but other harmonic wavelengths can be harvested for use in the metrology tool. For example, higher order harmonics of the FEL source output could be selected for use as wavelengths of interest in the CD-SAXS metrology tool, such as the third harmonic at 4.5 nm or the fifth harmonic at 2.7 nm, and so on, even if the first or fundamental harmonic is used for other purposes.

Another accelerator-based source that could be used is a synchrotron storage ring, which can generate broadband or narrowband light spanning from the visible down to hard X-ray wavelengths depending on the undulator and beam parameters. Although FELs can create significantly more in-band power, synchrotrons provide much easier tunability and lower facility costs.

Other known sources that generate soft X-ray outputs could be used with appropriate optical conditioning configurations, including plasma-based sources such as laser-produced plasma (LPP), dense-pinch plasma (DPP), laser-wakefield acceleration (LWFA), or high-harmonic generation (HHG).

### 2. CONDITIONING OPTICS

Assuming a light source that inputs a light beam in the soft X-ray range into a metrology tool, as noted above, this description focuses on techniques for filtering and conditioning the source light beam for use in optical metrology applications and other nanoscale inspections. For example, the features of interest and the desired physical and spatial characteristics associated with the features of interest are the known design objectives and of course provide the expected or predicted scattering response to an optical scan at a particular AOI. If the scattering response shows a variation from the expected response, there may be a need for a process control intervention.

The basic technique described herein is to provide a system of optics that is configured and positioned to receive the source beam and to filter and condition the source beam to provide a target beam for illuminating the wafer with a selected wavelength at the desired AOL. For many applications, the optical system will include at least one mirror positioned to receive the source light beam at an appropriate angle and configured with surface features, such as a grating or a multilayer coating, that are designed to reflect the specified wavelength of interest. For example, a multilayer coating can be designed to preferentially reflect the desired wavelength for a particular scan profile and to absorb undesired wavelengths (E. Spiller, “Low-loss reflection coatings using absorbing materials,” Appl. Phys. Lett. 20, pp. 365-67 (1972)).

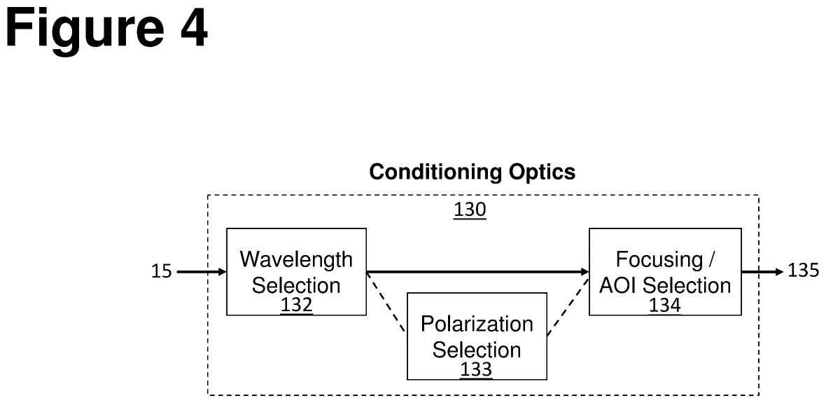

FIG. 4 is a simplified schematic representation of a conditioning optics system 130 within a metrology tool. At least two optics are provided: a first optic module 132 and a second optic module 134. The first optic module 132 is positioned at a small grazing angle to the beamline of the source beam 15 and is constructed with surface features designed to reflect and redirect a specified wavelength toward the second optic module 134. The second optic module 134 is positioned to receive the specified wavelength and to reflect and focus it as target beam 135 onto the wafer 105 at the specified AOL. The position and orientation of the first optic 132 and the second optic 134 in combination is what determines the AOI of the target beam 135.

A third optic module 133 can optionally be provided for imparting a desired polarization to the target beam 135. A polarization optic may be used to tune the polarization of the light and affect how the light scatters off the nanoscale structures on the wafer, yielding more information about the dimensions of these structures. For example, a system of mirrors that are tuned to the appropriate angles with each other will extinguish one polarization versus another using known methods. The design and implementation of each module depends on the application, and, in some cases, the functions can be combined into a single optical module. Illustrative examples are provided below.

While it is generally preferred to collect light that is reflected and scattered off the wafer directly into the detector, a set of collection optics (not shown) may also be provided between the wafer and detector, for example, to magnify or to filter the scattered light.

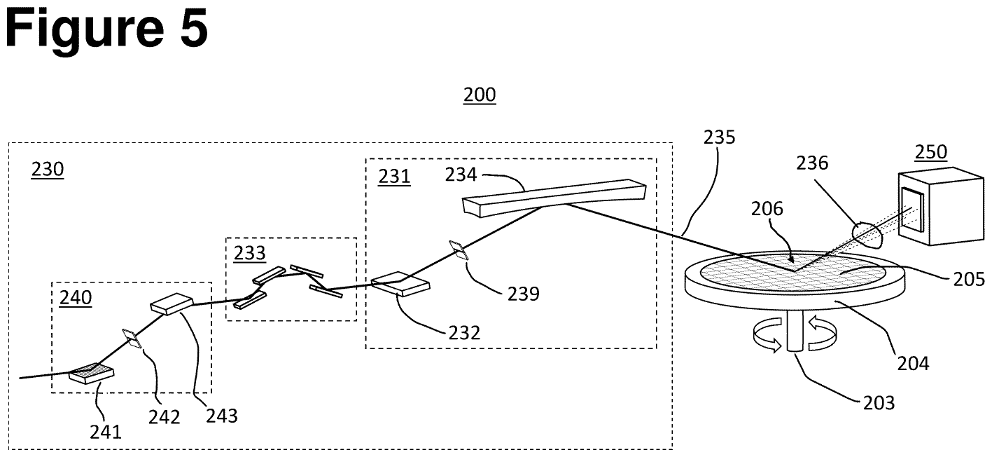

Referring now to FIG. 5, a more detailed metrology tool embodiment 200 having a conditioning optical system 230 is illustrated. The subject or target of the metrology tool is target point 206 on wafer 205, which is supported on platform 204 in a known manner. For example, the platform 204 typically includes a rotation and translation mechanism 203 or similar electromechanical interface for rotating and translating the position of the wafer into a series of different positions as part of a planned multi-position wafer scan profile using target beam 235. Further, while the wafer can be rotated around a given position to get more information at a single target site, the wafer will also be translated to other target sites to investigate metrology variations across the wafer.

The detector 250 is positioned to collect light 236 that is reflected and scattered by the wafer 205 at each position (radial and lateral) of the scan profile, and the results of the full scan profile will be evaluated against the design objectives for the feature of interest. Typically, a thin film filter (not shown) is placed in front of the detector to block undesired residual light from creating noise. In some implementations, the detector 250 may consist of an array of detector elements to increase the coverage of scattering and increase readout speed and sensitivity. Furthermore, in some implementations, a set of collection optics (not shown) is placed between the wafer and detector to increase magnification of the scattered light.

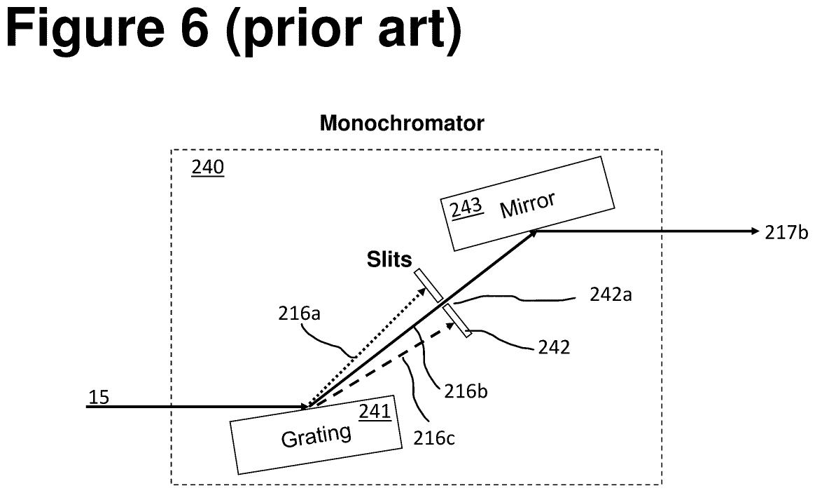

The conditioning optics system 230 of the metrology tool 200 may include an optic element 240 at the front end, namely a monochromator. As shown in FIG. 6, a typical monochromator 240 will include (i) a diffraction grating 241 configured to separate the source beam into its component wavelengths, each component is reflected off the grating in a different direction; (ii) an optical slit 242 positioned in the beamline of the source beam 15 to shape and pass the desired wavelength; and (iii) a mirror 243 positioned relative to the diffraction grating in order to reflect and focus the desired wavelength component into subsequent optics.

The optical grating 241 is positioned in the beamline of the source beam 15 with its reflective surface oriented at a known angle to the beamline. The grating 241 is constructed to diffract the source beam 15 into several different beams 216a, 216b, 216c, each having different wavelengths and reflecting at different diffraction angles. An optical slit module 242 is configured with at least one aperture 242a and positioned to select the desired wavelength 216b from among the diffracted beams and to pass that selected wavelength through the aperture but block other wavelengths. A collimating mirror 243 is positioned to receive the selected wavelength beam 216b and to focus the beam as a collimated beam 217b as an input for the focusing and AOI selection optics module 231.

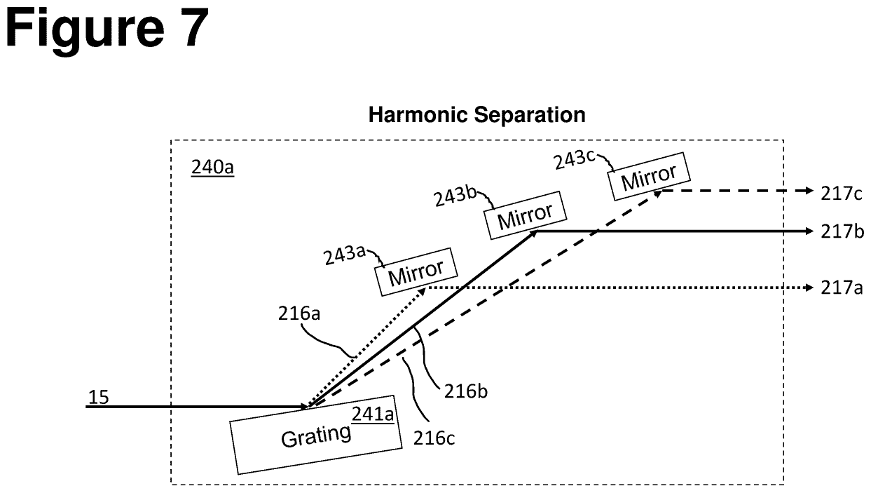

The grating 241 is formed by patterning the surface to create the desired periodic structure at a defined pitch. Thus, to select a particular wavelength of a narrow bandwidth FEL source beam, the pitch and the grating structure would be designed to reflect the desired wavelength in a particular direction (and to reflect other wavelengths in different directions). In fact, as shown in FIG. 7, a system 240a could be designed whereby each of the different wavelengths 216a, 216b, 216c separated by the grating 241 has its own collimating mirror 243a, 243b, 243c, respectively, in order to reflect the wavelengths separated by the grating into different tools. For selecting from the broader wavelengths generated by a synchrotron, the grating and slit parameters will be selected to match the multilayer coating or desired wavelength acceptance on focusing optic 234.

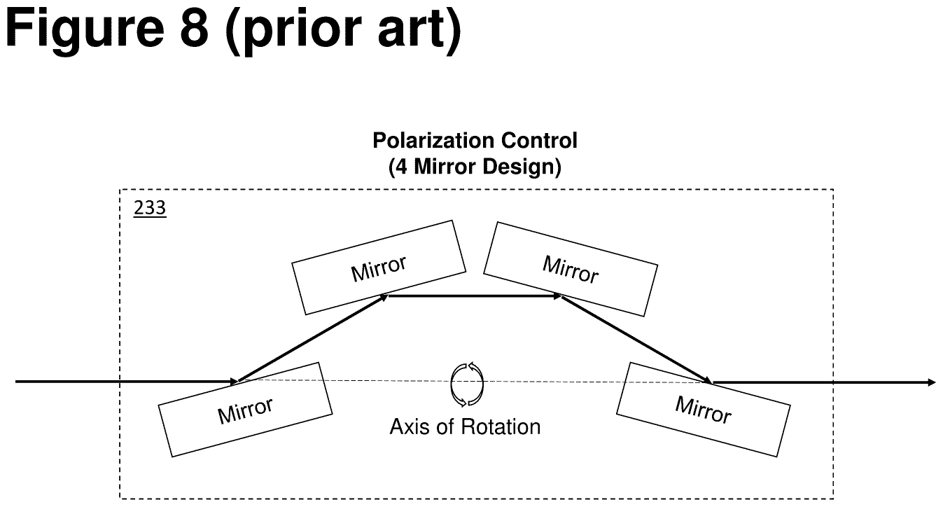

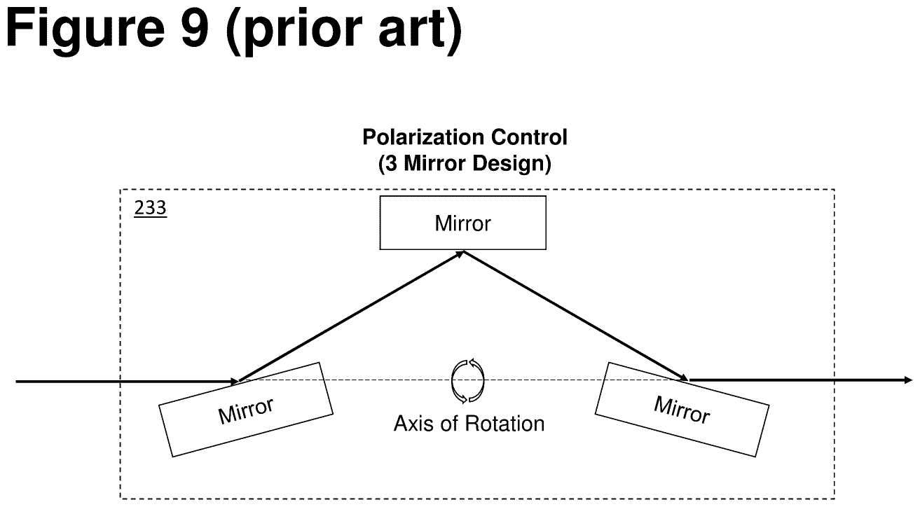

Returning to FIG. 5, a polarizer optic element 233 is positioned to receive the desired wavelength component from the monochromator 240 and to impart a desired polarization to the beam. The polarizer element 233 in this embodiment is shown as a four-mirror design, as illustrated in FIG. 8; but could have other configurations, such as the three-mirror design illustrated in FIG. 9. As previously mentioned, the polarizer element is optional and dependent on the specified scan profile.

The next element in FIG. 5 is optic element 231 designed for focus and AOI selection, including an optic element 232 positioned to receive the light beam from the polarizer optic 233, the light beam now consisting of a singular wavelength separated from the source beam and having the desired polarization. The optic element 232 is positioned to reflect the selected wavelength of light through an optical slit 239 onto a focusing optic element 234, which in turn reflects and focuses the light beam as the target beam 235 illuminating the semiconductor wafer 205 at the desired AOL. The desired AOI is set by the proper positioning and orientation of optic element 232 and optic element 234 as well as the acceptance of optical slit 239. Further, while optic element 232 could have a reflective surface formed in almost any type of shape, optic element 234 will generally be an ellipsoidal or paraboloidal mirror.

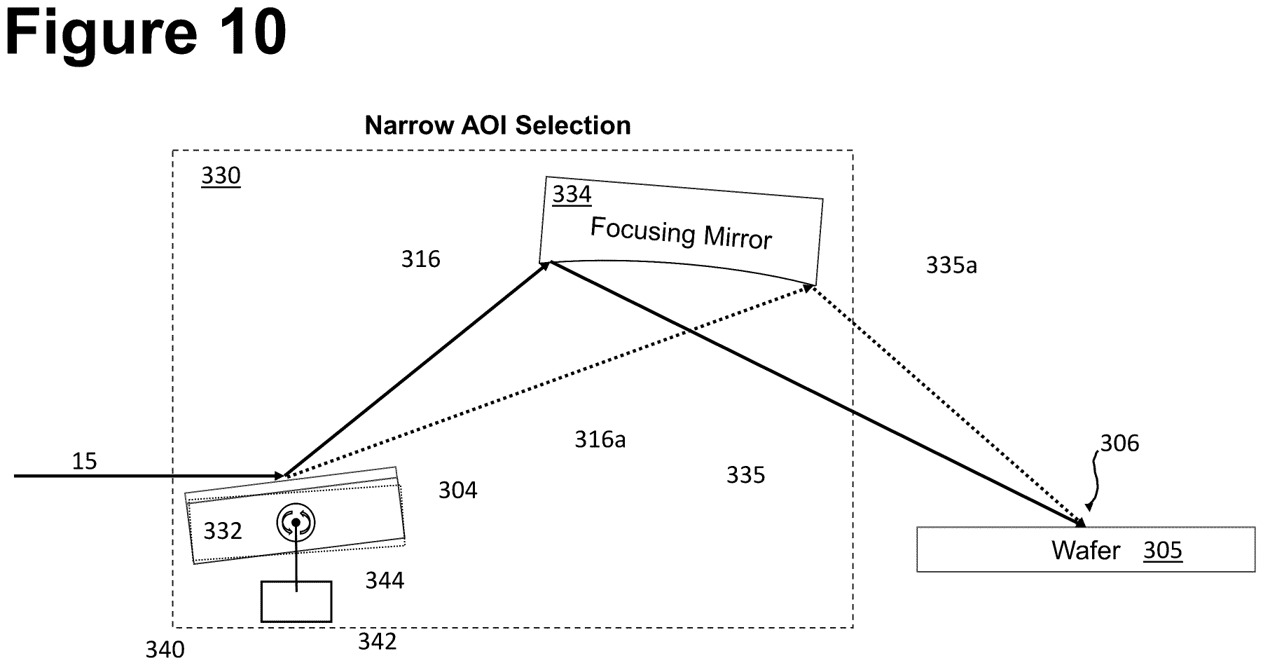

FIG. 10 illustrates a conditioning optics module 330, a variation which receives the source beam 15 at a particular input angle onto a scanning mirror 332. The scanning mirror 332 includes a multilayer coating 304 that is designed to reflect a specific desired wavelength from the source beam and redirect it as a collimated beam 316 toward, in this case, the near end of focusing mirror 334, which in this example is an ellipsoidal mirror. The focusing mirror 334 is designed and positioned to reflect the collimated beam 316 as target beam 335 at the desired AOI toward the target point 306 on wafer 305.

The scanning mirror 332 can be designed and positioned to redirect the source beam 15 toward any point on the focusing mirror 334. For example, an electromechanical assembly 340 can be coupled to the scanning mirror 332. An actuator 342 provides a signal to motor 344 to move the mirror into a different angular orientation, such as shown by the dashed lines. Thus, the dashed line position of scanning mirror 332 redirects beam 316a toward the far end of focusing mirror 334. Due to the elliptical surface of the focusing mirror 334, the resulting target beam 335, 335a, or anything in between, is always focused on the same wafer point 306.

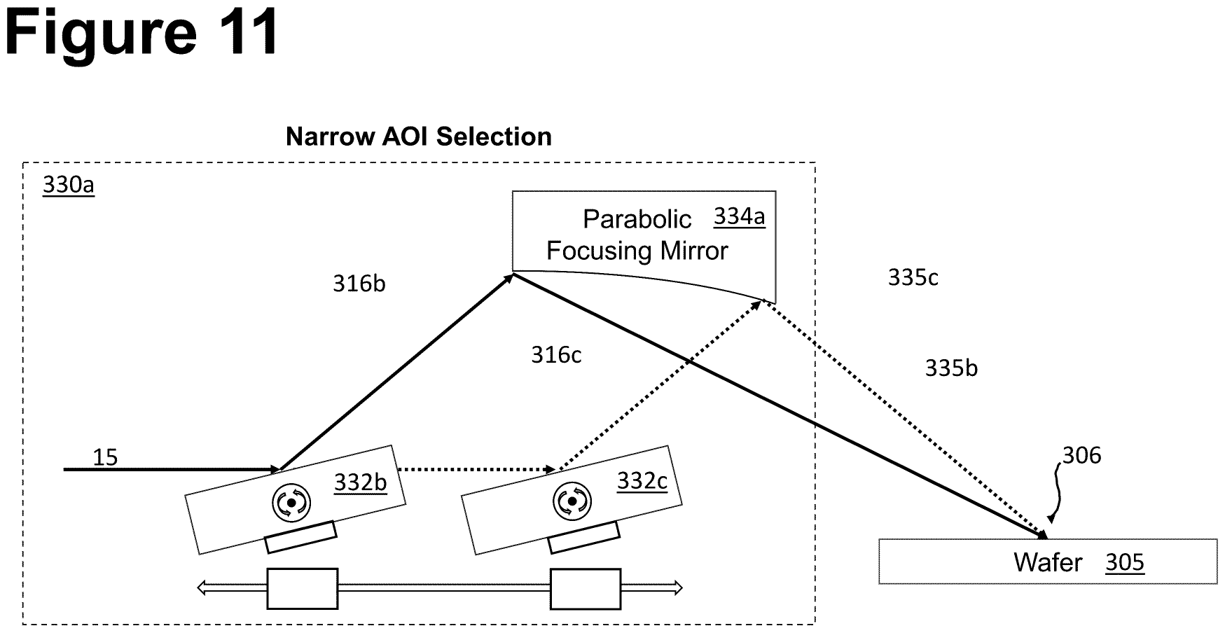

Referring to FIG. 11, conditioning optics module 330a is illustrated. In this example, the scanning mirror 332b with multilayer coating 304 reflects and redirects the collimated beam 316b toward the near end of focusing mirror 334a, which in this example is a parabolic mirror. The focusing mirror 334a reflects the collimated beam 316b as target beam 335b at a first desired AOI toward the target point 306 on wafer 305. However, the scanning mirror 332b can be translated laterally by electromechanical assembly 350 into position 332c (or any position in between) to redirect the source beam 15 toward the far end of focusing mirror 334a (or any position in between), but at a second, different desired AOI for target beam 335c, although still focused on the same wafer target point 306. A range of AOIs can thus be traversed by using the electromechanical assembly 350 to adjust the lateral position and/or the angular position of the scanning mirror.

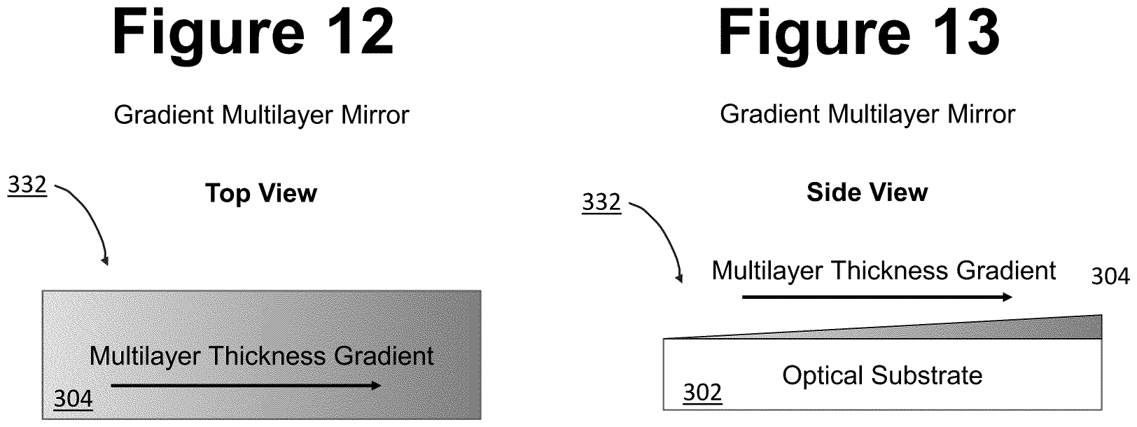

To maximize reflection from the scanning mirror 332, the multilayer coating must have the appropriate thickness as a function of angle. As shown in FIGS. 12 and 13, the multilayer coating 304 is applied to an optical substrate 302 with a thickness gradient that increases from the beginning, shown as light shading, to the end of the substrate, shown by dark shading, such that the thickness will be matched to a particular chosen angle.

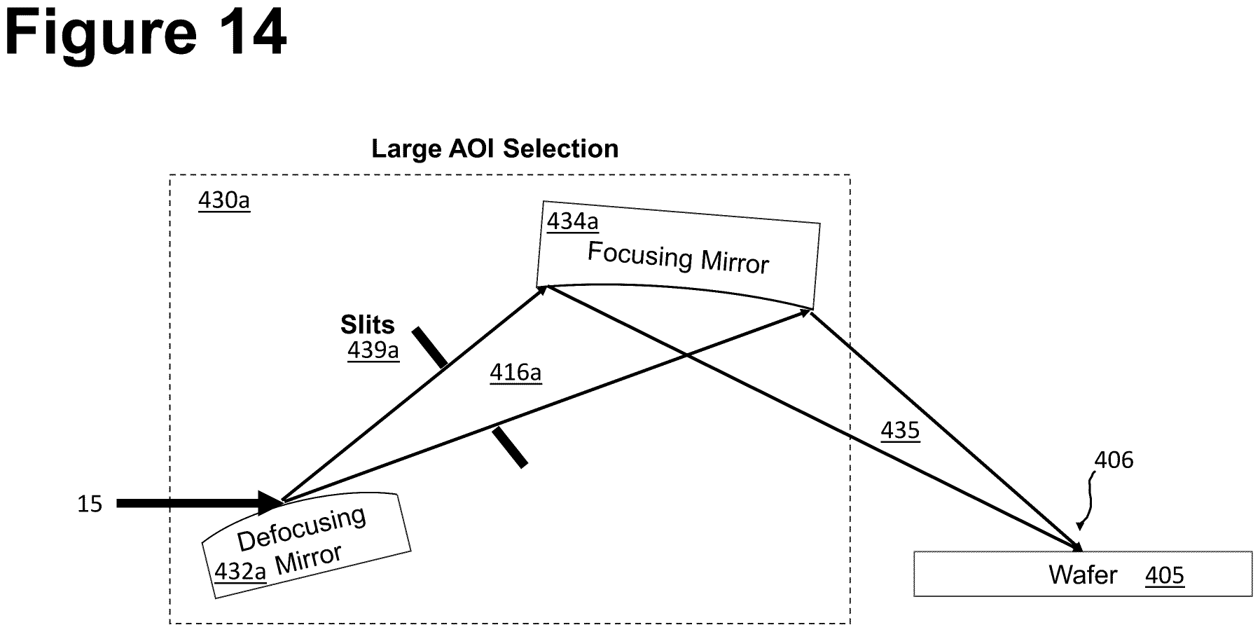

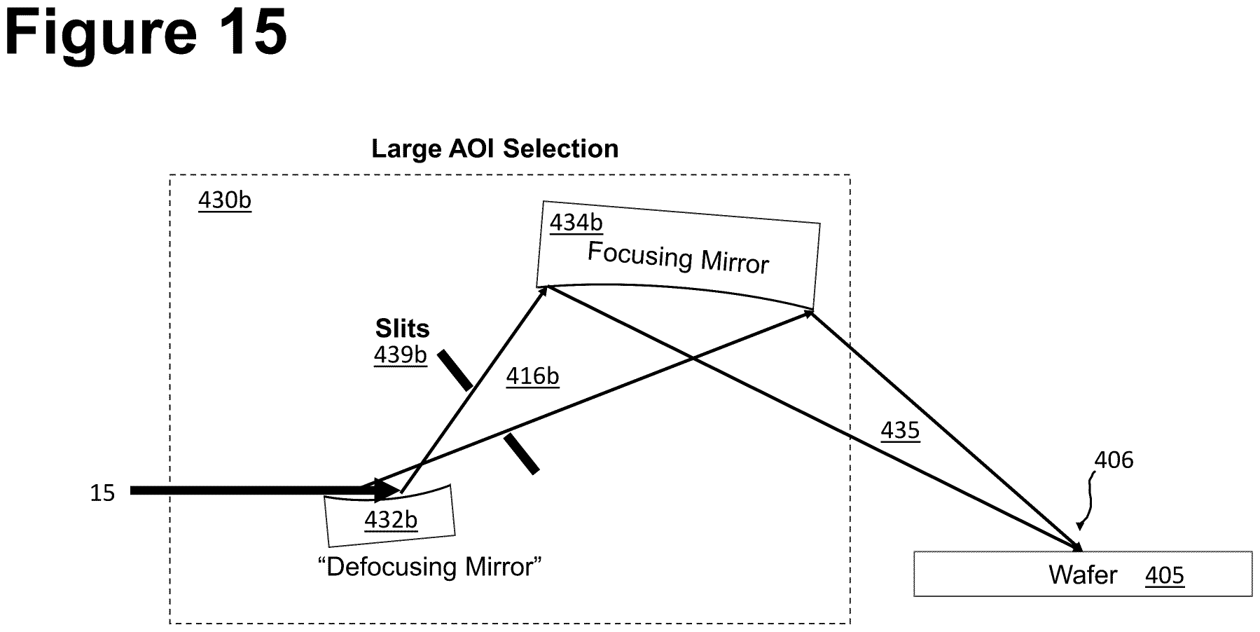

FIGS. 14 and 15 illustrate related alternative conditioning optics modules 430a, 430b. In FIG. 14, source beam 15 is directed into the conditioning optics 430a at a specified input angle toward a defocusing mirror 432a having a convex surface. The convex surface of the defocusing mirror 432a reflects and spreads out the source beam such that the large angular selection 416a of the source beam is directed onto the wide surface of the focusing mirror 434. The focusing mirror 434 is designed and positioned to converge the large angular selection 416a and reflect it as target beam 435, which is directed at the focus point 406 on wafer 405. Slits 439a placed between the defocusing and focusing optics can be used to adjust the angular selection of the target beam.

As shown in FIG. 15, the first mirror 432b could also be a concave focusing mirror, focusing the incoming source beam before expanding it on reflection into angular spread 416b. Once again, the focusing mirror 434b is designed and positioned to converge the large angular selection as the target beam 435 at the focus point 406 on wafer 405. Slits 439b placed between the defocusing and focusing optics can adjust the angular selection of light focused on the wafer.

In another alternative configuration, the reflection from a scanning mirror could be limited to a subset of the full angular range, for example, using an appropriate optical slit. In that event, the defocusing mirror could be tilted or rotated to different positions in order to scan the full angular range.

For many applications, the metrology tool will include an ellipsoidal mirror (as shown in the final focusing mirror configurations described above) positioned to receive the source light beam and coated with a multilayer coating. The multilayer coating is designed to preferentially reflect the desired wavelength for a particular scan profile and to absorb undesired wavelengths. In the typical example, the combination of an elliptical mirror and a multilayer coating acts to select the desired wavelength and to focus the input beam onto a small spot (ideally) on the wafer at the desired angle of incidence. The reflected and scattered light off the wafer is then captured by the detector(s).

Although use of a multilayer coating is the preferred method for wavelength selection in this application for the highest optical transmission at large angles (greater than 10 degrees from grazing) on the mirrors, metal coated mirrors with broadband wavelength acceptance at grazing angles below 10 degrees can be used in conjunction with an upstream monochromator for wavelength selection.

The AOI of the target beam for scanning the wafer will be highly dependent upon the information desired from the scan. In general, a sharp incidence angle on the wafer leads to less reflection and longer integration times for the detector; whereas a lower incidence angle generates a higher reflection, with less required integration time for the detector. The detector is positioned at an angle to match the incidence angle of the target beam or in a manner to collect the desired scattered components of the target beam on the wafer. Changing the incidence angle will of course change the scatter characteristics and the intensity levels of the detected light, and thus the angular and spatial positioning of the detector is critical for a particular scan profile.

The geometry and angular selection for an embodiment of the metrology tool intending to perform a scan of the wafer will be generally fixed. The multilayer coating is constructed of hundreds of alternating nanometer-scale layers of different materials with the layer thickness depending on wavelength and the angle of incidence of the source light beam on the mirror, such that each layer produces constructive interference of the reflected light and the layers collectively improve the overall reflectively to greater than 10%. The light source could be located approximately 1 to 200 meters distant to the first mirror depending on the facility, application, and source type. The focal length of the final mirror will be between 5 to 200 centimeters with the focal point on the wafer. The mirror (or a mirror array) may cover angles of incidence from approximately 5 to 50 degrees depending on the application. The detector will be placed approximately 5 to 100 centimeters from the focus on the wafer, depending on the angular resolution required for the specific application.

Although it is possible to create conditioning optics having a fixed angular geometry for a particular application at the selected wavelength, it is more desirable to have the ability to adjust the angular and spatial positioning of the conditioning optics and detector, both to tune the optics at a first angle for a first scan of the wafer and to adjust the system to a second angular configuration for a second scan of the wafer, and a third scan, etc. Thus, a first electro-mechanical system may be incorporated as part of the metrology tool and coupled to adjust the angular orientation of the conditioning optics. Likewise, a second electro-mechanical system may be incorporated as part of the metrology tool and coupled to adjust the angular orientation of the detector. A linear actuator is also preferably included on the detector stage to adjust the wafer-to-detector distance.

The conditioning optics, in particular wavelength selection, are very difficult to tune and align, and thus for practical reasons, the optical geometry will generally be optimized for a specific wavelength and be fixed as specified rather than adjustable in any manner. This of course suggests that in order to implement scan at a different wavelength, a different conditioning optic would be designed and optimized as a separate unit.

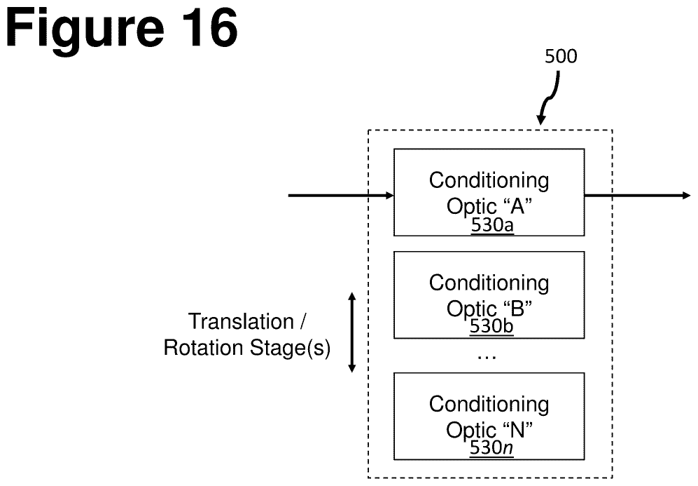

FIG. 16 is one example schematically illustrating a translation platform 500 having N different conditioning modules 530a, 530b . . . 530n affixed and positioned adjacent the source. When a scan at a first wavelength or AOI range is required, the platform 500 is translated or rotated into position for conditioning module 530a to receive and condition the source light beam. When a scan at a second wavelength or AOI range is required, the platform 500 is translated or rotated into position for conditioning module 530b to receive and process the source light beam, and so on for as many as N different conditioning modules.

### 3. DETECTOR

For CD-SAXS applications, it is preferred to collect reflected light directly into the detector through a filter in order to gain the most information from the scan and prevent any out-of-band radiation from creating noise on the detector. Magnification optics could be provided in the collected scattered light path to increase the spread of light angles, but this causes inefficiency due to transmission loss and more complexity for processing since magnification results in fewer photons collected per pixel and can lead to alignment errors.

### 4. CONCLUSION

All examples described above are illustrative and not intended to be limiting. All angles and spatial orientations of the embodiments described and shown in the Figures are also merely illustrative and not intended to be limiting.

1. An optical system for use in a metrology system to evaluate nanoscale features formed in a semiconductor substrate, comprising:
a plurality of optics having a geometric arrangement configured to create, from an incoming source beam in the soft-X-ray range, a target beam having a defined spectral, spatial, and angular distribution, the plurality of optics positioned for illuminating the semiconductor substrate with the target beam at a specified angle of incidence.

2. The optical system of claim 1, the plurality of optics comprising:
a first optic configured to reflect a first selected wavelength of the source beam; and
a second optic configured to focus the first selected wavelength received from the first optic onto the semiconductor substrate.

3. The optical system of claim 2, further comprising:
the first optic is a scanning mirror.

4. The optical system of claim 3, further comprising:
an electromechanical interface coupled to the scanning mirror for adjusting a position of the scanning mirror relative to the incoming source beam.

5. The optical system of claim 2, further comprising:
the second optic is an elliptical or ellipsoidal mirror.

6. The optical system of claim 2, further comprising:
the second optic is a parabolic or paraboloidal mirror.

7. The optical system of claim 1, the plurality of optics comprising:
a monochromator optic configured to pass a first wavelength of the source beam; and
a pair of optics configured to focus, at the specified angle of incidence, the first wavelength onto a target point of the semiconductor substrate.

8. The optical system of claim 1, further comprising:
a system of polarizer optics.

9. An optical system for conditioning a source beam in the soft X-ray range for use in a metrology system to evaluate nanoscale features formed in a semiconductor substrate, comprising:
at least two optics, including a first optic positioned to receive the source beam and configured to reflect a first beam portion of the source beam having a specific wavelength, and a second optic positioned to receive the first beam portion and configured to reflect and focus the first beam portion as a target beam onto a target point on the semiconductor substrate;
wherein the geometry and positions of the first optic and the second optic are set to illuminate the target point at a given angle of incidence;
and wherein light from the target beam is reflected and scattered off the semiconductor substrate and is collected and used to characterize the nanoscale features.

10. The optical system of claim 9, further comprising:
a monochromator positioned upstream of the first optic.

11. The optical system of claim 9, further comprising:
a polarizer positioned upstream of the first optic.

12. The optical system of claim 9, further comprising:
an electromechanical assembly coupled with the first optic for adjusting a position of the first optic.

13. The optical system of claim 9, wherein the first optic comprises:
a diffraction grating positioned to receive the source beam and configured to separate a plurality of wavelengths of the source beam and reflect the specific wavelength of the source beam at a particular reflection angle; and
a first collimating mirror positioned to receive the reflected specific wavelength of source beam and configured to further reflect the specific wavelength of the source beam toward the second optical element.

14. The optical system of claim 9, further comprising:
a diffraction grating positioned to receive the source beam and configured to reflect a plurality of wavelengths of the source beam into different directions;
a plurality of collimating mirrors each positioned to receive a distinct one of the plurality of wavelengths of the source beam from the diffraction grating, and each collimating mirror configured to further reflect the distinct wavelength of the source beam toward one of a plurality of second optical elements;
wherein each of the plurality of second optical elements reflects and focuses the distinct wavelength onto a respective one of a plurality of semiconductor substrates.

15. The optical system of claim 9, wherein the first optical element comprises:
a mirror having a multilayer coating on its surface and positioned to receive the source beam, the multilayer coating configured to reflect the specific wavelength of the source beam; and
a first mirror positioned to receive the reflected specific wavelength of source beam and configured to further reflect the specific wavelength of the source beam toward the second optic.

16. The optical system of claim 15, further comprising:
the multilayer coating is formed with a thickness gradient from one end of the mirror to the other.

17. The optical system of claim 13, further comprising:
an optical slit positioned between the grating and the first collimating mirror, the slit configured to shape and pass the reflected specific wavelength of the source beam.

18. The optical system of claim 9, further comprising:
the first optic is a scanning mirror; and
the second optic is a focusing mirror;
wherein the scanning mirror is configured to reflect a narrow angular selection of the specified wavelength toward a selected point on the focusing mirror.

19. The optical system of claim 9, further comprising:
the first optic is a defocusing mirror; and
the second optic is a focusing mirror;
wherein the defocusing mirror is configured to reflect a large angular selection of the specified wavelength toward a selected point on the focusing mirror.

20. The optical system of claim 19, further comprising:
an optical slit positioned between the scanning mirror and the focusing mirror.

21. The optical system of claim 9, further comprising:
the first optic is configured to reflect a large angular selection of the specified wavelength toward substantially an entire surface of the focusing mirror.

22. A tool for semiconductor metrology, the tool is coupled to a light source that provides a source beam in the soft X-ray range, comprising:
a platform holding and positioning a semiconductor substrate;
an optical system configured to redirect a portion of the source beam toward the semiconductor substrate at a specific angle of incidence, the optical system including at least two optical elements, including a first optical element configured to receive the source beam and to reflect a portion of the source beam having a specified wavelength, and a second optical element configured to receive the reflected portion of the source beam and to reflect and focus the reflected portion as a target beam onto the semiconductor substrate; and
a detector positioned to receive and process light from the target beam that is reflected and scattered from the nanoscale features of the semiconductor substrate.

23. A tool for semiconductor metrology as in claim 22, further comprising:
a plurality of optical systems, each optical system configured to redirect a distinct portion of the source beam having a different wavelength toward the semiconductor substrate at an angle of incidence that corresponds to the different wavelength; and
an electromechanical assembly for selecting one of the plurality of optical systems and moving the selected optical system into a position to scan the semiconductor substrate; and
wherein the corresponding angle of incidence for each optical system is set by the positioning and orientation of the respective optical system.

24. A tool for semiconductor metrology used to evaluate nanoscale features formed in a semiconductor substrate, the tool is coupled to a light source that provides a source beam in the soft X-ray range as input to the tool, comprising:
a platform holding and positioning a semiconductor substrate;
a detector positioned to receive and process light that is reflected and scattered from the nanoscale features of the semiconductor substrate; and
an optical system configured to redirect a portion of the source beam toward the semiconductor substrate at a specific angle of incidence, the optical system including:
a monochromator positioned in the beamline to separate wavelengths of the input beam;
a polarizer positioned between the monochromator and the first optical element and configured to impart a desired polarization to the input beam;
a wavelength selecting optic configured to receive the input beam and to reflect the portion of the input beam having a specific wavelength, and
a focusing optic configured to receive the reflected portion of the input beam and to reflect and focus the reflected portion as a target beam onto the semiconductor substrate;
wherein the specific angle of incidence is set by the positioning and orientation of the wavelength selecting optic and the focusing optic.
